(19) United States
(12) Patent Application Publication
(10) Pub. No.: US 2018/0105454 A1
(43) Pub. Date: Apr. 19, 2018

(54) A LITHIUM METASILICATE GLASS CERAMIC AND PREPARATION METHOD THEREOF

(71) Applicant: Shenzhen Upcera Dental Technology Co., Ltd, Guangdong (CN)

(72) Inventors: Yanchun ZHENG, Liaoning (CN); Guoyi SONG, Liaoning (CN); Hongjuan WANG, Guangdong (CN)

(21) Appl. No.: 15/517,595

(22) PCT Filed: Aug. 27, 2015
(86) PCT No.: PCT/CN2015/088248

§ 371 Date: Apr. 7, 2017

(30) Foreign Application Priority Data
Jun. 4, 2015 (CN) 201510304854.3

(51) Int. Cl. C03C 10/00; C03B 32/02

(52) U.S. Cl. CPC C03C 10/0027; C03C 10/0054; C03B 32/02

(57) ABSTRACT

A preparation method of lithium metasilicate glass ceramic, comprises (a) preparing a melt of glass matrix; (b) pouring the melt of glass matrix into a mould, and cooling to obtain a blank of glass matrix; (c) placing the blank of glass matrix in a heating device to carry out heat treatment, the process parameters of which include: heating to a temperature of 450-600° C. under a heating rate of 5-20° C./min, and keeping the temperature for 20-150 min; and cooling along with the heating device to obtain the lithium metasilicate glass ceramic after the heat treatment. Compared with the prior art, in the resulted lithium metasilicate glass ceramic, the main crystal phase of lithium metasilicate exhibits the crystal morphology of sphere which is in nano-size and uniform. The lithium metasilicate glass ceramic is low in crystallization degree, and thus has reduced hardness.

The present application claims the priority of Chinese Application 201510304854.3 filed before the SIPO on Jun. 4, 2015, under the title of “A lithium metasilicate glass ceramic and preparation method thereof”. The whole contents thereof are incorporated into the present application by reference.

### TECHNICAL FIELD

The invention relates to the field of ceramics, in particular to a lithium metasilicate glass ceramic and preparation method thereof.

### BACKGROUND ART

Lithium disilicate glass ceramics are widely applied in dental prosthesis field due to good mechanical property and excellent aesthetic effect.

However, the strength of lithium disilicate glass ceramic is generally above 350 MPa, which leads to difficulties in shaping processing. In order to solve the problem of shaping processing, in the prior art, lithium metasilicate glass ceramic are usually produced from glass matrix, then shaped, and heat-treated to obtain lithium disilicate glass ceramic. The strength of lithium metasilicate glass ceramic is lower than that of lithium disilicate glass ceramic, thus, it is relatively easy to conduct the shaping processing of lithium metasilicate glass ceramic.

Two-step heat treatment process is generally adopted in the prior art to produce lithium metasilicate glass ceramic. Namely, the heat treatment for nucleation of glass matrix is carried out at relatively low temperature first, and then the heat treatment for crystallization is carried out at relatively high temperature, for example at about 650° C., to obtain lithium metasilicate glass ceramic.

In practical application, the drawbacks are present in the above-mentioned two-step heat treatment.

(1) The production process is relatively complicated due to requiring two-step heat treatment. Further, the lithium metasilicate has a narrower temperature range of crystallization, and is sensitive to crystallization temperature, thereby having high requirements for production device.

(2) The lithium metasilicate obtained by using two-step heat treatment in the prior art after crystallization heat treatment has platy or flaky crystal morphology, as shown in FIG. 1. The lithium metasilicate glass ceramic has high hardness of about 6000 MPa, due to high crystallization degree of the glass ceramics obtained by using two-step heat treatment. Although such lithium metasilicate glass ceramic, compared with lithium disilicate glass ceramic, is easier to be shaped, nevertheless, the wear of the milling bur or grinding tool during the process is severe due to the comparatively higher hardness, and thus the whole processing period is long.

(3) The resulted lithium metasilicate glass ceramic has poor transparency, and the defects existed inside, such as bubbles, subfissure and the like cannot be observed easily, which is not good for the quality test of products.

### SUMMARY

In order to overcome the drawbacks of above-mentioned two-step heat treatment process of lithium metasilicate glass ceramic, the invention provides a preparation method of lithium metasilicate glass ceramic, comprising

(a) preparing a melt of glass matrix comprising the components below:

SiO₂: 60.0 wt %-74.0 wt %,

Li₂O: 10.0 wt %-20.0 wt %,

K₂O: 0.5 wt %-5.0 wt %,

Al₂O₃: 2.0 wt %-5.0 wt %,

P₂O₅: 2.5 wt %-10.0 wt %,

wherein, the weight percent of each component is based on the total weight of the melt of glass matrix;

(b) pouring the melt of glass matrix into a mould, and cooling to obtain a blank of glass matrix; and

(c) placing the blank of glass matrix in a heating device to carry out heat treatment, the process parameters of which include: heating to a temperature of 450-600° C. at a heating rate of 5-20° C./min, keeping the temperature for 20-150 min, and cooling along with the heating device to obtain the lithium metasilicate glass ceramic after the heat treatment.

In practical application, in order to adjust the transparency and color of the obtained lithium metasilicate glass ceramic, the melt of glass matrix can further comprise the components below in addition to the components above:

at least one of 0 wt %-3.5 wt % of B₂O₃, 0 wt %-10.0 wt % of ZrO₂, 0 wt %-5.0 wt % of ZnO, 0 wt %-1.5 wt % of MgO, 0 wt %-2.0 wt % of La₂O₃, 0 wt %-2.5 wt % of Na₂O, 0 wt %-2.0 wt % of CaO and 0.1 wt %-10.0 wt % of coloring oxides, based on the total weight of the melt of glass matrix. In a preferred embodiment, the coloring oxides can be selected from at least one of the oxides of iron, titanium, vanadium, manganese, copper, chromium, cobalt, nickel, selenium and rare earth metals. In a preferred embodiment, the rare earth metals can be selected from at least one of cerium, terbium, erbium, neodymium, praseodymium, samarium, and europium.

It should be noted that the above components can be obtained from the corresponding carbonates, nitrates, sulfates or oxides respectively.

In the technical solution of the invention, the step (a) of preparing the melt of glass matrix can be achieved by the conventional technical means, and thus is not described in detail herein.

Specifically, in some preferred embodiments, the method for preparing the melt of glass matrix comprises:

weighting raw materials corresponding to the components according to the weight percent of the components, grinding by ball milling machine for 2-5 hours, preferably 2-3 hours, mixing them well, and sieving through 100 mesh to obtain the batch;

introducing the batch into a corundum crucible or a platinum crucible, heating to a temperature of 1500-1550° C. at a heating rate of 10-15° C./min in a sintering furnace, keeping the temperature for 0.5-3 hours, completely melting, degassing, clarifying and homogenizing to obtain the melt of glass matrix.

In some preferred embodiments of the invention, after preparing the melt of glass matrix, the glass melt can be rapidly poured into the metal mould preheated at 300° C.-450° C. in advance, and a transparent blank of glass matrix can be formed after cooling down along the mould. Usually, it can be cooled to room temperature.

In some other preferred embodiments of the invention, in order to further homogenize the blank of glass matrix, the melt of glass matrix can be subjected to water quenching by directly pouring into cold water after prepared in step (a) to obtain small pieces of glass matrix. Then, the small pieces of glass matrix can be dried at 100-150° C. for 1-2 hours, melted into melt of glass matrix, poured into a mould, and cooled to obtain the blank of glass matrix.

In the invention, the object of the invention can be achieved by utilizing the process parameters for the heat treatment of heating to a temperature of 450-600° C. at a heating rate of 5-20° C./min, and keeping the temperature for 20-150 min.

Of course, some preferred embodiments can be utilized for achieving better technical effects.

In some preferred embodiments of the invention, the heating rate is preferably 5-15° C./min.

In some other preferred embodiments of the invention, it is preferred to heat to 500-600° C., more preferably to 560-590° C.

In yet some preferred embodiments of the invention, the time for keeping the temperature is preferably 60-120 min.

In yet some preferred embodiments of the invention, the lithium metasilicate glass ceramic obtained by the preparation method according to the invention can be shaped by hot-press shaping technique with loss-wax, or CAD/CAM (computer aided design/computer aided manufacturing) technique.

It should be noted that, the devices used for realizing the technical solution of the invention, such as ball milling machines for grinding raw materials, sintering furnaces for preparing glass melt, and electric resistance furnaces for heat treating are well known in the prior art. Suitable devices can be chose by one skilled in the art in practice, and thus is not described in detail in the invention.

According to the preparation method in the invention, lithium metasilicate glass ceramic can be simply obtained by heat treating the melt of glass matrix at 450-600° C. in one-step.

Compared with the two-step heat treatment process in the prior art, the preparation method of the invention possesses the following advantages.

(1) Only one step of heat treatment is required. Thus, the production process is simple. Further, the crystallization heat treatment at high temperature is not needed, and thus the requirements for the production device are relatively low.

(2) In the resulted lithium metasilicate glass ceramic, the main crystal phase of lithium metasilicate exhibits crystal morphology of sphere which is nano-sized and uniform, as shown in FIG. 2. The lithium metasilicate glass ceramic has low crystallization degree, and thus has reduced hardness. This can reduce the wear of the milling bur or grinding tool during the process, and shorten the whole processing period.

(3) The resulted lithium metasilicate glass ceramic has high transparency and can be semitransparent or even transparent, such that the defects such as bubbles or impurities existed in the lithium metasilicate glass ceramic can be found easily. This is convenient to the quality test procedures of products.

Besides, the microcracks resulted from processing or grinding are easily recovered or sealed due to crystal transforming and growing during the process of secondary crystallization, i.e. the process that the main crystal phase in the ceramic is transformed from spheric lithium metasilicate into lath-shaped lithium disilicate (as shown in FIG. 7, in which the temperature for heat treatment of glass ceramics is 560° C., and the temperature for secondary crystallization is 850° C.).

### BRIEF DESCRIPTION OF THE DRAWINGS

For better understanding of the technical solution of the invention or the prior art, the figures used for illustrating the examples or prior art are briefly described. Apparently, only some examples of the invention are illustrated in the figures. Other figures can be obtained according to these figures without inventive effort for one skilled in the art.

FIG. 1 is the Scanning Electron Microscope image of a commercially available lithium metasilicate glass ceramic prepared by two-step heat treatment process;

FIG. 2 is the Scanning Electron Microscope image of the lithium metasilicate glass ceramic prepared in example 2;

FIG. 3 is the XRD pattern of the lithium metasilicate glass ceramic prepared in example 2;

FIG. 4 is the Scanning Electron Microscope image of the lithium metasilicate glass ceramic prepared in example 4;

FIG. 5 is the XRD pattern of the lithium metasilicate glass ceramic prepared in example 4;

FIG. 6 is the XRD pattern of the commercially available lithium metasilicate glass ceramic prepared by two-step heat treatment process; and

FIG. 7 is the Scanning Electron Microscope image of the lithium disilicate ceramic obtained by subjecting the lithium silicate metasilicate glass ceramic prepared according to the method of the invention.

### DETAILED DESCRIPTION

The technical solution in the example of the invention will now be described clearly and completely with reference to the figures. It is obvious that the described examples are only a part of examples of the invention, not all of them. Based on the examples of the invention, all the other examples obtained by one skilled in the art without inventive effort are within the protection scope of the invention.

The Preparation of Lithium Metasilicate Glass Ceramic

### Example 1

(a) The weight of each component in example 1 shown in table 1 was converted to the weight of corresponding raw material thereof. Then the corresponding raw materials of respective components were weighted, and grinded by ball milling machine for 3 hours, then mixed well, and sieved with a 100 mesh sieve to obtain the batch;

the batch was placed in a corundum crucible, and heated in a sintering furnace to 1500° C. at a heating rate of 13° C./min, kept for 1 hour, degassed, clarified and homogenized to obtain a melt of glass matrix;

(b) the melt of glass matrix was poured into a metal mould at a temperature of 300° C., and cooled to room temperature to obtain the blank of glass matrix; and

(c) the blank of glass matrix was placed in a electric resistance furnace to carry out heat treatment, the process parameters of which include: heating to a temperature of 480° C. at a heating rate of 5° C./min, and keeping the temperature for 150 min, and cooled along with the furnace to room temperature after the heat treatment, thereby obtaining the lithium metasilicate glass ceramic.

### Example 2

According to the components of the melt of glass matrix in example 2 shown as table 1, the lithium metasilicate glass ceramic was prepared in a similar way with example 1 except that

after being prepared in step (a), the melt of glass matrix was directly poured into cold water for water quenching, and thus small pieces of glass matrix were obtained, then dried at 150° C. for 2 hours, melted into a melt of glass matrix at 1500° C. after drying; the melt of glass matrix was poured into a metal mould at a temperature of 350° C., and cooled to room temperature to obtain a blank of glass matrix.

The process parameters of heat treatment included: heating to a temperature of 560° C. at a heating rate of 8° C./min, and keeping the temperature for 120 min.

The prepared lithium metasilicate glass ceramic was subjected to Scanning Electron Microscope test and XRD (X-ray diffraction) test.

The Scanning Electron Microscope test was performed by using a field emission scanning electron microscopy of type MIRA3 TESCAN with an acceleration voltage of 10.0 kV.

The XRD test was performed by using the X-Ray Diffractometer type D/max 2500, Rigaku, with CuKa-radiation, at an external voltage of 40.0 kV, an anode current of 30.0 mA, and a slit of 0.3 mm under a scanning range of 20°-80°.

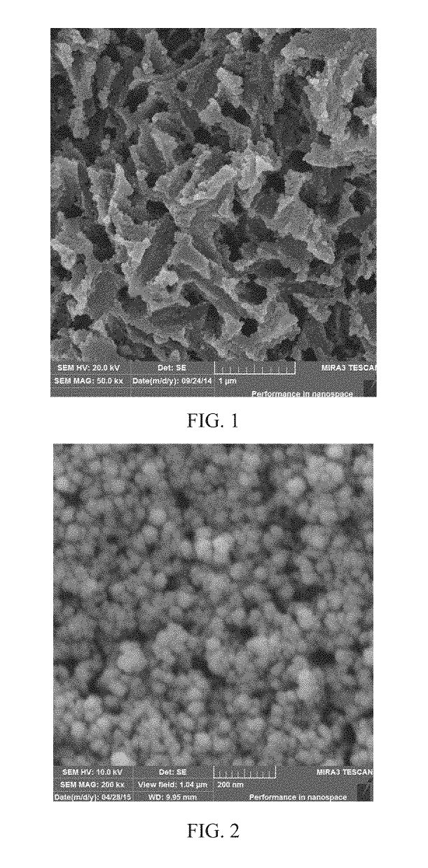

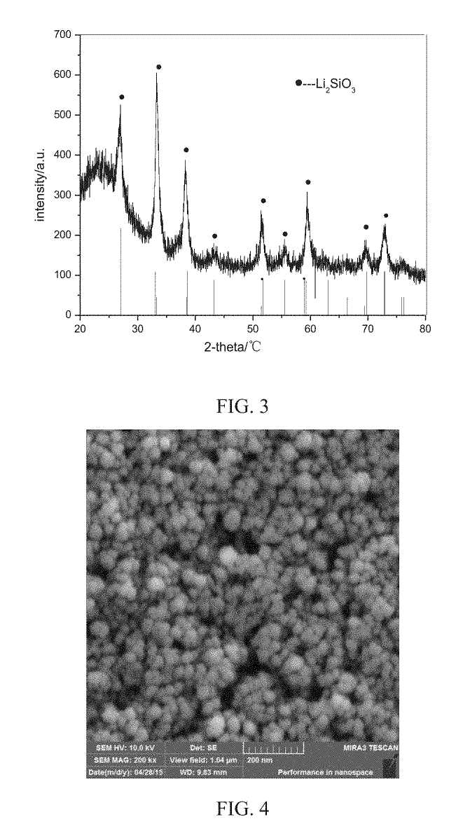

The test results were shown in FIG. 2 and FIG. 3 respectively.

From FIG. 2, it can be seen that the obtained product exhibits uniform sphere in crystal morphology and has a crystal size of 30-60 nm.

From FIG. 3, it can be seen that distinct diffuse scattering peaks are present at 20°-30° in XRD pattern for the lithium metasilicate glass ceramic prepared after heat treating at 560° C., indicating that major of glass phase exists in the lithium metasilicate glass ceramic prepared in example 2 and thus the content of the crystal phase is low. Further, the feature peaks of X-ray are in conformity with standard PDF card, indicating that the glass ceramic with main crystal phase of lithium metasilicate is obtained in example 2. After calculation, the content of crystal phase of sample in example 2 is 31.77%.

The calculation method for the content of crystal phase is provided blow.

The content of crystal phase of sample is calculated by X-ray diffraction data.

The software for calculation is XRD analysis software MDI Jade 6.5. The specific steps include:

1. collecting the XRD data by Jade software;

2. smoothening the curve;

3. removing the background data;

4. listing each peak position;

5. confirming whether all the peaks are listed;

6. clicking “print” to print the original data report before peak-differentiation, so as to be used for the correction of 2T and h; and

7. peak-differentiating and fitting: \textcircled{1} peak-differentiating, \textcircled{2} inputting the amorphous peaks, \textcircled{3} differentiating the crystal peaks, \textcircled{4} displaying the results of manual differentiation, \textcircled{5} correcting values of “2T” and “h”, and \textcircled{6} fitting.

Therefore, a relatively stable content of crystal phase can be obtained.

### Example 3

According to the components of the melt of glass matrix in example 3 shown as table 1, the lithium metasilicate glass ceramic was prepared in a similar way with example 2 except that the heat treatment was carried out under the condition of heating to a temperature of 520° C. at a heating rate of 5° C./min, and keeping the temperature for 90 min.

### Example 4

According to the components of the melt of glass matrix in example 4 shown as table 1, the lithium metasilicate glass ceramic was prepared in a similar way with example 2 except that the heat treatment was carried out under the condition of heating to a temperature of 580° C. with a heating rate of 5° C./min, and keeping the temperature for 60 min.

The prepared lithium metasilicate glass ceramic was subjected to Scanning Electron Microscope test and XRD (X-ray diffraction) test. The conditions for the Scanning Electron Microscope test and XRD (X-ray diffraction) test were the same as those described in example 2.

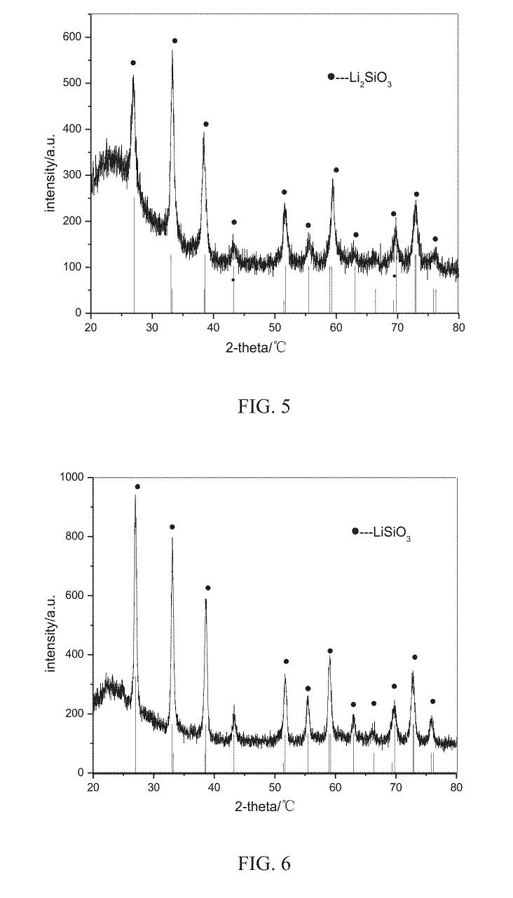

The test results were shown in FIG. 4 and FIG. 5.

From FIG. 4, it can be seen that the obtained product exhibits uniform sphere in crystal morphology, and has a crystal size of 30-60 nm.

From FIG. 5, it can be seen that distinct diffuse scattering peaks are present at 20°-30° in XRD pattern for the lithium metasilicate glass ceramic prepared after heat treating at 580° C., indicating that major of glass phase exists in the lithium metasilicate glass ceramic prepared in example 4 and thus the content of the crystal phase is low. Further, the feature peaks of X-ray are in conformity with standard PDF card, indicating that the glass ceramic with main crystal phase of lithium metasilicate is obtained in example 4. The content of crystal phase of sample in example 4 is 35.68%, calculated by using the method described in example 2.

Further, the commercially available lithium metasilicate glass ceramic prepared by two-step heat treatment was subjected to Scanning Electron Microscope test and XRD (X-ray diffraction) test.

The Scanning Electron Microscope test was performed by using a field emission scanning electron microscopy of type MIRA3 TESCAN with an acceleration voltage of 20.0 kV.

The XRD test was the same as that of example 2.

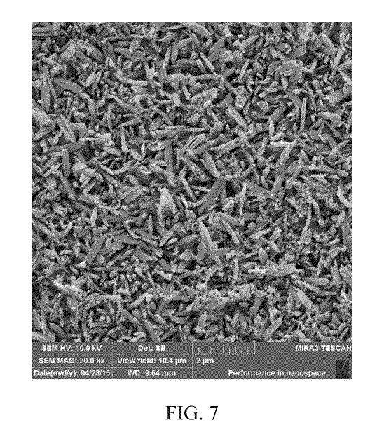

The test results were shown in FIG. 1 and FIG. 6, respectively.

From FIG. 1, it can be seen that the commercially available lithium metasilicate glass ceramic prepared by two-step heat treatment process is platy or flaky in crystal morphology, and has a micron-sized crystal.

From FIG. 6, it can be seen that, compared with example 2 and example 4, for the commercially available lithium metasilicate glass ceramic prepared by two-step heat treatment process, the intensity of diffraction peak is significantly much stronger, and the intensity of diffuse scattering peaks of glass phase is relatively weaker, indicating that the content of crystal phase thereof is higher than the samples in example 2 and example 4 to some extent. The content of crystal phase of the commercially available lithium metasilicate glass ceramic sample prepared by two-step heat treatment process is 57.37%, calculated by using the method described in example 2.

### Example 5

According to the components of the melt of glass matrix in example 5 shown as table 1, the lithium metasilicate glass ceramic was prepared in a similar way with example 2 except that the heat treatment was carried out under the condition of heating to a temperature of 590° C. at a heating rate of 20° C./min, and keeping the temperature for 25 min.

TABLE 1
The weight of each component in the melt of glass matrix in examples 1-5

| | Example 1 | Example 2 | Example 3 | Example 4 | Example 5 |
|---|---|---|---|---|---|
| SiO₂ | 60.0 | 65.0 | 67.5 | 68.1 | 70.5 |
| Li₂O | 20.0 | 13.5 | 14.0 | 14.5 | 14 |
| K₂O | 5.0 | 4.0 | 3.5 | 3.0 | 3.2 |
| Al₂O₃ | 5.0 | 2.5 | 3.5 | 4.0 | 2.0 |
| P₂O₅ | 10.0 | 4.3 | 3.6 | 3.3 | 5.5 |
| B₂O₃ | — | 2.5 | 1.7 | 3 | — |
| ZrO₂ | — | 1.6 | 1.5 | 0.5 | 3.7 |
| ZnO | — | 1.2 | 1.0 | — | — |
| MgO | — | 0.1 | 0.5 | — | 0.6 |
| La₂O₃ | — | 0.5 | 0.2 | — | — |
| Na₂O | — | 0.3 | 0.3 | 0.4 | — |
| CeO₂ | — | 1.5 | 1.0 | 1.7 | 0.4 |
| V₂O₅ | — | 0.8 | 0.5 | 0.8 | — |
| Er₂O₃ | — | 1.2 | 0.2 | 0.7 | 0.1 |
| Tb₂O₃ | — | 1.0 | 1.0 | — | — |

* The weight of each component in above table is expressed in gram.

The lithium metasilicate glass ceramics prepared in examples 1-5 were processed into regular shape such as cube. The strength, hardness and density of the obtained lithium metasilicate glass ceramics were tested. The cubic glass ceramics was attached to a handle, and then processed into green body of dental prosthesis by CAD/CAM (computer aided design/computer aided manufacturing). The processability of the prepared lithium metasilicate glass ceramics was tested. The results were shown in table 2.

TABLE 2
The tested results of the processability of the lithium metasilicate glass
ceramics prepared in examples 1-5

| | Example 1 | Example 2 | Example 3 | Example 4 | Example 5 |
|---|---|---|---|---|---|
| Main crystal | Lithium | Lithium | Lithium | Lithium | Lithium |
| phase | metasilicate | metasilicate | metasilicate | metasilicate | metasilicate |
| Strength | 98.4 | 127.2 | 115.8 | 131.6 | 132.5 |
| MPa | | | | | |
| Hardness | 5200 ± 100 | 5500 ± 100 | 5400 ± 100 | 5600 ± 100 | 5700 ± 100 |
| MPa | | | | | |
| Density | 2.468 | 2.475 | 2.472 | 2.474 | 2.470 |
| g/cm³ | | | | | |
| State of the | Transparent | Transparent | Transparent | Semitransparent | Semitransparent |
| product | | | | | |
| Processability | Less | No chipping, | No chipping, | No chipping, and | No chipping, and |
| (compared | chipping, | and quicker | and quicker | general | slightly quicker |
| with the | and similar | processing | processing | processing speed | processing speed |
| two-step heat | processing | speed | speed | | |
| treatment | speed | | | | |
| process) | | | | | |

From the data in the above table, it can be seen that the hardness of the lithium metasilicate glass ceramic prepared in examples 1-5 is about 5500 MPa, and is significantly decreased comparing with that of the glass ceramics prepared by two-step heat treatment process. Thus, the wear of the milling bur or grinding tool during the process can be reduced, and the whole processing period also can be shortened. The resulted lithium metasilicate glass ceramic has high transparency and can be semitransparent or even transparent, such that the defects such as bubbles or impurities existed in the lithium metasilicate glass ceramic can be found easily. The result of this is convenient to the quality test procedures of products. Moreover, the processibility is somewhat improved, and the problems such as chipping or breaking, etc. can be avoided.

Furthermore, the transparency of the lithium metasilicate glass ceramic prepared by the method of the invention is higher than that prepared by two-step heat treatment process. This indicates that the lithium metasilicate glass ceramic prepared by the method of the invention has low content of crystal phase, and high content of glass phase, which is also an important factor for reduced hardness.

The shaped green body of prosthesis does not meet the requirements for dental prosthesis, whether mechanical aspects or aesthetic aspects, and thus a further secondary crystallization treatment is needed.

The secondary crystallization treatment can be achieved by using related technique recited in prior art, and thus is not described in detail herein. Specifically, the used process can include: placing a shaped green body of prosthesis in a porcelain furnace, and heating to 850° C. at a heating rate of 50° C./min, keeping the temperature for 10 min, and cooling along with the porcelain furnace to obtain the prosthesis of lithium disilicate glass ceramic.

The lithium metasilicate glass ceramics prepared in examples 1-5 were shaped into green bodies of dental prosthesis by CAD/CAM, and subjected to the secondary crystallization treatment above. The results were shown in table 3.

TABLE 3
The results for the lithium metasilicate glass ceramics prepared in examples
1-5 after the secondary crystallization treatment

| | Example 1 | Example 2 | Example 3 | Example 4 | Example 5 |
|---|---|---|---|---|---|
| Main crystal | Lithium | Lithium | Lithium | Lithium | Lithium |
| phase | disilicate | disilicate | disilicate | disilicate | disilicate |
| Strength MPa | 358.4 | 369.1 | 395.5 | 403.6 | 402.3 |
| Transparency | Opaque | High | Low | High | High |
| | | transparency | transparency | transparency | transparency |

From table 3, it can be seen that the main crystal phase of the glass ceramics is transformed from lithium metasilicate into lithium disilicate after the secondary crystallization treatment. After the main crystal phase being transformed into lithium disilicate, the glass ceramic has strength of higher than 350 MPa, and transparency in different extent, which can meet the strength and aesthetic requirements for a dental prosthesis.

In addition to the above-mentioned CAD/CAM technique, the hot-press technique with loss-wax can also be used for shaping the lithium metasilicate glass ceramics. Specifically, wax molding can be produced by manual caking, machining or 3D printing, and then hot-press shaping at 850° C. to 950° C. by the process such as embedding, preheating, and loss wax, etc., thereby obtaining products such as dental prosthesis having main crystal phase of lithium disilicate and the strength of higher than 350 MPa, and possessing the texture and gloss similar with natural tooth.

It should be noted that the above examples are only the preferred examples of the invention without limiting the protection scope of the invention. Any amendments, equivalent replacements, developments made within the spirits and principles of the invention are all included in the protection scope of the invention.

1. A preparation method of lithium metasilicate glass ceramic, characterized in comprising
(a) preparing a melt of glass matrix comprising the components below:
SiO₂: 60.0 wt %-74.0 wt %,
Li₂O: 10.0 wt %-20.0 wt %,
K₂O: 0.5 wt %-5.0 wt %,
Al₂O₃: 2.0 wt %-5.0 wt %,
P₂O₅: 2.5 wt %-10.0 wt %,
wherein the weight percent of each component is based on the total weight of the melt of glass matrix;
(b) pouring the melt of glass matrix into a mould and cooling to obtain a blank of glass matrix; and
(c) placing the blank of glass matrix in a heating device to carry out heat treatment, the process parameters of which include: heating to a temperature of 450-600° C. at a heating rate of 5-20° C./min, and keeping the temperature for 20-150 min; and cooling the blank of glass matrix to obtain the lithium metasilicate glass ceramic after the heat treatment.

2. The preparation method according to claim 1, characterized in, the melt of glass matrix further comprises:
at least one of 0 wt %-3.5 wt % of B₂O₃, 0 wt %-10.0 wt % of ZrO₂, 0 wt %-5.0 wt % of ZnO, 0 wt %-1.5 wt % of MgO, 0 wt %-2.0 wt % of La₂O₃, 0 wt %-2.5 wt % of Na₂O, 0 wt %-2.0 wt % of CaO and 0.1 wt %-10.0 wt % of coloring oxides, based on the total weight of the melt of glass matrix.

3. The preparation method according to claim 2, characterized in that the coloring oxides are selected from at least one of the oxides of iron, titanium, vanadium, manganese, copper, chromium, cobalt, nickel, selenium and rare earth metals.

4. The preparation method according to claim 1, characterized in that, the method for preparing the melt of glass matrix comprises:
weighting raw materials corresponding to the components according to the weight percent of components, grinding, and mixing them well to obtain the batch; and
heating the batch to 1500-1550° C. at a heating rate of 10-15° C./min, and keeping the temperature for 0.5-3 hours, completely melting, clarifying and homogenizing to obtain the melt of glass matrix.

5. The preparation method according to claim 1, characterized in, after preparing the melt of glass matrix in step (a), further comprising:
subjecting the melt of glass matrix to water quenching to obtain small pieces of glass matrix, then drying the small pieces of glass matrix at 100-150° C. for 1-2 hours, and melting the small pieces of glass matrix into the melt of glass matrix;
then pouring the melt of glass matrix into a mould and cooling to obtain a blank of glass matrix defined in step (b).

6. The preparation method according to claim 1, characterized in, preheating the mould to 300-450° C. before pouring the melt of glass matrix into it.

7. The preparation method according to claim 1, characterized in that the process parameters of the heat treatment include a heating rate of 5-15° C./min.

8. The preparation method according to claim 1, characterized in that the process parameters of the heat treatment include heating to 500-600° C.

9. The preparation method according to claim 1, characterized in that the process parameters of the heat treatment include keeping the temperature for 60-120 min.

10. The preparation method according to claim 1, characterized in that the resulted lithium metasilicate glass ceramic is shaped by CAD/CAM technique or hot-press shaping technique with lost-wax.

11. A lithium metasilicate glass ceramic prepared by the preparation method according to claim 1, characterized in that the lithium metasilicate glass ceramic has crystal morphology of sphere, crystal size of 30-60 nm, and content of crystal phase of 20-40%.

12. The lithium metasilicate glass ceramic according to claim 11, characterized in that the melt of glass matrix further comprises:
at least one of 0 wt %-3.5 wt % of B₂O₃, 0 wt %-10.0 wt % of ZrO₂, 0 wt %-5.0 wt % of ZnO, 0 wt %-1.5 wt % of MgO, 0 wt %-2.0 wt % of La₂O₃, 0 wt %-2.5 wt % of Na₂O, 0 wt %-2.0 wt % of CaO and 0.1 wt %-10.0 wt % of coloring oxides, based on the total weight of the melt of glass matrix.

13. The lithium metasilicate glass ceramic according to claim 12, characterized in that the coloring oxides are selected from at least one of the oxides of iron, titanium, vanadium, manganese, copper, chromium, cobalt, nickel, selenium and rare earth metals.

14. The preparation method according to claim 1, characterized in that the process parameters of the heat treatment include heating to 560-590° C.
